(19) United States
(12) Patent Application Publication
(10) Pub. No.: US 2016/0037237 A1
(43) Pub. Date: Feb. 4, 2016

(54) SYSTEM AND METHOD FOR ENCODING AUDIO BASED ON PSYCHOACOUSTICS

(71) Applicants: John Wilkinson, W. Sussex (GB); Richard John Steele Hawksworth, Combe Florey (GB)

(72) Inventors: John Wilkinson, W. Sussex (GB); Richard John Steele Hawksworth, Combe Florey (GB)

(21) Appl. No.: 14/811,817

(22) Filed: Jul. 28, 2015

Related U.S. Application Data
(60) Provisional application No. 62/030,541, filed on Jul. 29, 2014.

(51) Int. Cl. H04N 21/8545; H04N 21/81; H04N 21/858; H04N 21/4725; H04N 21/439; H04N 21/845; H04N 21/4782; G06Q 30/02; H04N 21/41

(52) U.S. Cl. CPC H04N 21/8545; G06Q 30/0241; H04N 21/812; H04N 21/858; H04N 21/4126; H04N 21/439; H04N 21/8455; H04N 21/4782; H04N 21/4725

(57) ABSTRACT

In one embodiment, a method for creating interactive content is provided. The method comprises embedding at least one tag into audio associated with video content; wherein said tag, is inaudible to a human due to the phenomenon of psychoacoustics; and

associating at least one action to be performed when the tag is decoded by a client device.

This application claims the benefit of priority U.S. Provisional Patent Application No. 62/030,541 entitled “AUDIO BASED ON PSYCHOACOUSTICS” which was filed on Jul. 29, 2014, the entire specification of which is incorporated herein by reference.

### FIELD

Embodiments of the present invention relates to advertising.

### BACKGROUND

Advertisers, Program Makers and other individuals or organizations who publish video Or audio content to any place by any means would like better mechanisms for measuring who is watching/listening to their content and would like the means to engage the viewer/listener on their mobile or other secondary devices.

For example the creators of a TV commercial would find very useful the ability to track who watched their commercial, when they watched it, whether they watched the whole commercial or just a part, what other device they were using while watching, and to be able to kick off an activity on that secondary device such as load a new app or visit a website or map location.

### SUMMARY

In one embodiment, a method for creating interactive content is provided. The method comprises embedding at least one tag into audio associated with video content; wherein said tag is inaudible to a. human due to the phenomenon of psychoacoustics; and

associating at least one action to be performed when the tag is decoded by a client device.

Other aspects of the invention disclosed herein will be apparent and the detailed description that follows.

### BRIEF DESCRIPTION OF THE DRAWINGS

FIG. 1 shows an exemplary setup in accordance with one embodiment of the invention wherein a primary device transmits audio embedded with an in audible tag or trigger to a secondary device.

FIG. 2 shows processing blocks in accordance with one embodiment of the invention for embedding audio tags.

FIG. 3 shows a block diagram of hardware that may be used to implement the techniques disclosed herein, in accordance with one embodiment of the invention. One

[symbol]

### DETAILED DESCRIPTION OF SOME EMBODIMENTS

In the following description, for purposes of explanation, numerous specific details are set forth in order to provide a thorough understanding of the invention. It will be apparent, however, to one skilled in he art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may he requirements for some embodiments but not other embodiments. Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the invention disclose techniques and systems for embedding short messages or tags that represent inaudible sounds for transmission from a primary device (TV, Radio, any device capable of accurately transmitting audio) to a secondary device (Phone, Tablet, computer or any device capable of receiving and decoding audio).

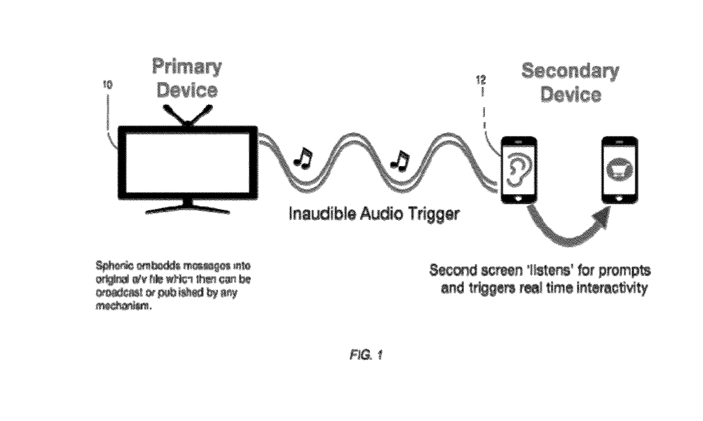

For example, referring to FIG. 1, audio associated with programming played on a primary device 10 in form a television may be encoded with at least one tag (also known as an “inaudible audio trigger”. Said audio may be transmitted via speakers associated with the device 10 to a secondary device 12, which may be a mobile phone of a user.

In one embodiment, the process for tagging the audio may exploit the phenomena of Psychoacoustics. Specifically, the way that the human ear and brain works means that there are certain conditions whereby we cannot hear certain sounds in certain situations. In particular, the tags are embedding based on Simultaneous Frequency Masking. This facilitates the embedding of tags/messages/signals using frequencies that a human could otherwise potentially hear in the absence of the psychoacoustic effects. (The common .MP3 audio file encoding method uses the reverse of this process to achieve high compression by discarding audio that cannot be heard).

In one embodiment, prior to embedding a signal into an audio source, the signal is encoded using Forward Error Correction (FEC) to allow for detecting and repairing of errors that occur during transmission. The specific method. of FEC employed is Low Density Parity Check (LDPC, in one embodiment.

In one embodiment, for the embedding of the signal itself into the audio, pairs of specific frequencies may be used to drive Biphase Mark Coding of the encoded message.

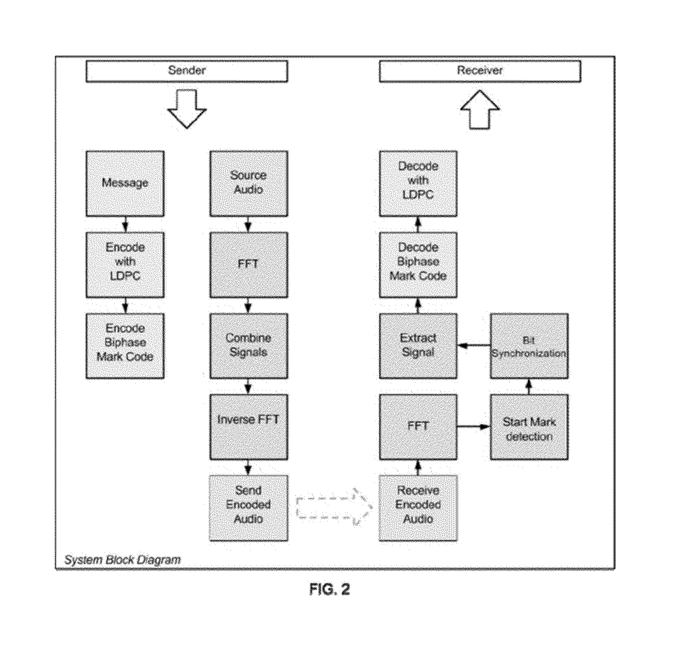

FIG. 2 shows the processing blocks for encoding and decoding of tags in audio, in accordance with one embodiment. Referring to FIG. 2, blocks that deal with data in the Time domain are shown in green, blocks that deal with information in the frequency domain are shown in red, and blocks that deal with digital message data are shown in orange. More details on the processing blocks shown in FIG. 2 are provided in appendix i, together with details of some terms used herein.

The encoding techniques described herein may be used to overcome many of the problems of encoding and reliably decoding an inaudible message in a noisy environment.

Some exemplary use cases for the encoding techniques disclosed herein include:

### Encoding by Customer:

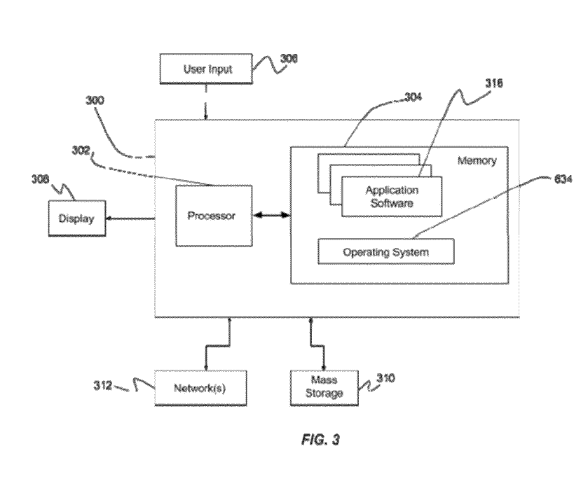

In one embodiment, an online service for embedding tags (also referred to herein as “Sphenic tags”) provided. Said online service may be embodied in a system such as the system shown and described with reference to FIG. 3 of the drawings. The online service allows a customer to upload content in the form of a video or audio item to an online editor. The system pre-processes the uploaded video and the areas in the video best suited to tagging are highlighted for the user. As the user moves through the timeline in the video they will only be able to insert tags in these areas. Tags can be deleted and moved. The tags can also have actions attached to them in the editor which can be modified and enhanced. For instance such an action might be to open a specific Application using some deep links to specific sections in that application. For example Facebook could be opened for a particular user at the wall. These tags are then encoded and inserted into the content using the techniques disclosed herein.

The enhanced content with the embedded trigger may then be downloaded and deployed in any way the customer desires. Alternatively, the customer may be provided with a SDK or plugins to allow on-premises encoding of tags rather than in-cloud encoding.

### Decoding by End User:

A “helper application” which collaborates with any customer mobile application or a custom app, is deployed to end user devices (normally phones or tablets but potentially any device capable of listening to and processing audio) to listen for tags in any customer content which is being played in proximity to the device. Actions as set by the customer at encoding may then be triggered. Information as to what tags were detected by the device along with other associated data available on the device maybe be passed back to online service for processing and analysis. For example, in one embodiment the tags disclosed, herein may be embedded into audio associated with an advertisement that is broadcast two television receivers. In this case, the helper application may be provisioned on a client device such as a mobile phone or tablet device. The helper application listens to the television broadcast, and decodes the tags embedded in the advertisement even though said tags are completely inaudible to a human. Suppose the advertisement is for a new motor vehicle. In this case, exemplary action associated with a tag may comprise causing the client device to launch a browser and display a page with content relating to the advertisement. For example, said content may comprise an invitation to test drive a motor vehicle at a local dealership.

The following Table 1 below summarizes the benefits of the technology disclosed herein to advertisers, broadcasters, program makers, and rights owners.

| | | | Program | Rights |
|---|---|---|---|---|
| | Advertisers | Broadcasters | Makers | Owners |
| Improved Metrics/ | X | X | X | X |
| Demographics | | | | |
| Increases value | | X | | |
| of commercial | | | | |
| minutes | | | | |
| Increases value of | | | X | |
| program | | | | |
| Offer Incentives | X | | | |
| (for watching | | | | |
| content) | | | | |
| Watermarking | | | X | X |
| (knowing when/ | | | | |
| where seen) | | | | |
| Point of sale | X | | X | |
| revenue sharing | | | | |
| Reconnection | X | X | X | X |
| with end user | | | | |

### Monitoring BSIDS as an Alternative To Audio Tags.

Presently every wireless access point broadcasts a basic service set identification (BSSID) which uniquely identifies said access point. Mobile devices with wifi turned on will automatically can for these IDs and installed software can take action based on detecting a specific ID, in the same way software can act on hearing a Sphenic tag. An example of this includes a Sphenic enabled app for a supermarket chain configured to sense that the device (and consequently owner) was in a particular store and trigger actions such as suggest they visit a certain aisle/item in the store on special offer, or provide a personalized voucher, in the same manner as if they had received a Sphenic audio tag.

### Timing Responses To Events in Live Broadcasts

There is almost always a delay from the time a studio camera captures an event to the event being displayed on a customer's TV screen. Moreover, it can take several seconds for an analog TV signal to be digitized. Also there may be an artificial delay of several seconds introduced to sensor certain words. Then there is another delay when signal is broadcast over satellite. These delays may be cumulative, and consequently one customer may view a “live” broadcast several seconds before another. For this reason an application that requires a timed response to events appearing on screen is not really possible. However if a Sphenic code is inserted into a broadcast, any receiving app can be sure a response was made within a specific time period relative to the tag. For example a game show app where contestants at home can play along and answer questions the system can be certain that their responses were made before any answers were revealed, no matter how lagged the broadcast is.

### Using Sphenic Tags in Radio

In one embodiment, Sphenic tags may be encoded in a pure audio stream (i.e. without video) so it is entirely possible to use them in in radio broadcasts Radio ads could trigger actions on mobile devices, and popularity of radio shows or segments could be monitored using Sphenic tags.

### Ticketing

It has long been common practice to check validity of tickets at airline desks, concert and other venues by scanning printed barcodes, QR codes or other unique visual identifiers using dedicated scanning equipment. More recently mobile apps have been created that allow use of a camera to scan tickets in the same way. Also electronic tickets can be generated by a mobile app that displays a Barcode/QR code in place of a paper ticket which can then be scanned by another device. In one embodiment. Sphenic audio tags may be placed inside a generic. sound and played by an app to “transmit” a ticket identity to a. receiving device, likely another mobile device with a microphone. One advantage to this approach is that Sphenic audio tags are silent and can accurately be detected at a much greater distance than a camera or laser scanner can detect a barcode.

### Progressive Awards System

For most applications using Sphenic silent audio tags, the detection of a single tag will be recorded and logged or used to create an action in an app. However some customers will likely require a method of detecting the same tag, or a number of tags, or sequence of related tags to gauge how often the end user viewed/listened to an item or group of related items. Thus, in one embodiment a plurality or progress tags may be embedded in audio to give the customer to configure outcomes and actions based on the detection of each tag in the plurality. In this way incentives can be offered for instance for observing how far the viewer got through a commercial. The viewer would be asked to click in the mobile app 25%, 50%, 70% and 100% through the advert. This would be timed so if they don't respond to 25% tag before the 50% tag arrives then you can be sure they were not watching at the start. in one embodiment, the tagging technology disclosed herein may be implemented as tagging software running on a server. Said server may be accessible to customer over a wide area network (WAN) such as the Internet. In one embodiment, a customer mobile device may be provisioned with a Sphenic app configured to decode Sphenic tags and to initiate actions associated with the tags.

FIG. 3 shows a high-level block diagram of exemplary hardware 300 representing a system to tag audio as described herein The system 300 may include at least one processor 302 coupled to a memory 304. The processor 302 may represent one or more processors (e.g., microprocessors), and the memory 304 may represent random access memory (RAM) devices comprising a main storage of the hardware, as well as any supplemental levels of memory e.g., cache memories, non-volatile or back-up memories (e.g. programmable or flash memories), read-only memories, etc. in addition, the memory 304 may be considered to include memory storage physically located elsewhere in the hardware, e.g. any cache memory in the processor 302, as well as any storage capacity used as a virtual memory, e.g., as stored on a mass storage device.

The system also typically receives a number of inputs and outputs for communicating information externally. For interface with a user or operator, the hardware may include one or more user input/output devices 306 (e.g., keyboard, mouse, etc.) and a display 308. For additional storage, the system 300 may also include one or more mass storage devices 310, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 312 (e.g., a local area network (LAN), a wide area network (WAN), a wireless network, and/or the Internet among others) to permit the communication of information with other computers coupled to the networks. It should he appreciated that the hardware typically includes suitable analog and/or digital interfaces between the processor 302 and each of the components, as is well known in the art.

The system 300 operates under the control of an operating system 314, and executes application software 316 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of full functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Although the present invention has been described with reference to specific exemplary 225 embodiments, it will be evident that the various modification and changes can be made to these embodiments without departing from the broader spirit of the invention. Accordingly, the specification and drawings are to be regarded in an illustrative sense rather than in a restrictive sense.

1. A method for mating interactive content, the method comprising:
embedding at least one tag into audio associated with video content; wherein said tag is inaudible to a human due to the phenomenon of psychoacoustics; and
associating at least one action to he performed when the tag is decoded by a client device.

2. The method of claim 1, further comprising highlighting selected portions of said that your content best suited for embedding said at least one tag.

3. The method of claim 1, wherein said video content may comprise an advertisement.

4. The method of claim 3, wherein said at least one action may comprise causing the client device to access a web page wherein further information relating to a product associated with said advertisement can be found.
